(19) United States
(12) Patent Application Publication
(10) Pub. No.: US 2008/0072633 A1
(43) Pub. Date: Mar. 27, 2008

(54) SECURITY DEVICE

(76) Inventor: Elsamma Samuel, Kuala Lumpur (MY)

Correspondence Address: DARBY & DARBY P.C., P.O. BOX 770, Church Street Station, New York, NY, 10008-0770, US

(21) Appl. No.: 11/534,999

(22) Filed: Sep. 25, 2006

(51) Int. Cl. E05B 73/00

(52) U.S. Cl. 70/58

(57) ABSTRACT

The present invention relates to a security device that is used with a cable lock which prevents removal of any portable objects from a location where the objects are placed. The security device is a lock adaptor (10) which is used on or with the cable lock (12) to lock and prevent removal of the portable objects. The lock adaptor (10) includes at least one means to receive locking tongue (18) and one means to receive the cable (14) of the cable lock (12) there through. The lock adaptor (10) is selected from a group consisting tube (26), ring (28), plate (30), disc (32), modified pad lock (34) and modified wire tie (36). The present invention also includes cable lock adaptor extension cords (50) and modified cable (14) of the cable locks (12). Besides that, the present invention also relates to a power security system in lock adaptors (10), cable (14) of the cable locks (12) and housing (58) of the cable (14). This sensing and alarm means will help to sound an alarm, trigger a message, automatically send SMS, or give a call to authorized personal when the cable lock (12) is tampered.

### FIELD OF INVENTION

This invention relates to the security of personal properties, and more particularly, to an apparatus securing easily removable, free standing personal properties such as computers, suitcases, bicycles, helmet to motorbikes, pets, phones, Personal Digital Assistant (PDA), or displayed items.

### BACKGROUND OF THE INVENTION

Laptops, notebook computers, Personal Digital Assistant (PDA) and objects that are portable and hand carried such as travel bags, back packs, computer bags are often stolen from offices, houses, shops and while traveling. As computers and other valuables are becoming smaller and portable, the chances of these being stolen are greatly increased. When left unattended, these things are easily stolen. Besides that, while traveling or while waiting in ports, users of small valuable things would like to take a nap, or leave the things securely and would like to go somewhere, such as toilet. Similarly, while having food at the restaurant, one like to relax and enjoy, without having the worry of someone stealing our belongings such as computer bag, travel documents, and other valuables/essentials in the suitcases.

Portable computer cable lock described in U.S. Pat. No. 5,327,752 is becoming very popular nowadays as it helps to lock laptop, desktop and even monitors in offices, houses, shops or in hotels. It is a cable with a “locking head” on one end and a “loop” to connect with a stationary object or a pole on the other end. The “tongue” of the locking head needs to be inserted into the “locking hole” or the “locking security slot” on the laptop. The cable locks that are described in the prior art, to secure laptops, are made of a cable, of which one end is a loop and the other end a lock body. The lock assembly can allow locking through a latch hole (computer chassis security slot) normally present in the new laptops (described in U.S. Pat. No. 6,463,770 B1). The thickness of the wall of the computer chassis is important and a new lock assembly is presented (U.S. Pat. No. 6,708,535 B1) that works regardless of the slot width. The loop of the cable is reeved around an immovable object (or a post) and the latch is received into the latch hole of the laptop. In a very recent U.S. Pat. No. 7,013,685, the cable lock loop is modified into housing, and the cable can be stored in the housing, and can be retracted when needed. This modification helps in the easy storage and portability of the cable lock.

With the computer cable lock available in market today, the computer is protected. However, the computer bag (that often containing documents), and other briefcases that are used in the home, shops, office or while traveling are not secured. Therefore the computer bags and contents of the briefcases are easily stolen from the bag. Length of the cable lock is also fixed to secure an object from a certain distance.

The present invention aims to solve the limitations of the current computer cable lock, and allows one to lock their computer, computer bag or several suitcases and other personal properties. Another advantage of the present invention is the same cable lock can be used with the present invention to lock the laptops, monitors, suitcases, displayed valuables in a shop or airport, bicycles, helmet to motor cycles, pets or literally articles that need to be secured, at the same time, or when needed.

### SUMMARY OF THE INVENTION

The preferred embodiment of the present invention relates to an apparatus for securing portable objects comprising a cable at one end of which is attached to a lock head with locking tongue and other end of the cable is a loop means or has a means to form a loop like structure. The apparatus above describes a cable lock. The apparatus further comprising at least one lock adaptor which includes at least one means to receive locking tongue of the lock head and one means to receive the cable of the cable lock. The cable can be of any flexible elongate member selected from a group consisting cable, chain, tape, rod, cord, string and strap or combination thereof. The lock adaptor is selected from a group consisting tube, ring, plate, disk, modified pad lock and modified wire-tie wherein the modified pad lock includes at least one means to receive locking tongue made or fused either on its body or on its locking clamp and wherein the modified wire-tie includes one means to receive locking tongue attached or fused or connected to the modified wire-tie.

The lock adaptor is rotatable about the cable of the cable lock and moveable along the cable to minimize kinking of the cable lock. The means to receive the locking tongue is either spaced apart or inherent to the lock adaptor. For the tube, at least one insert is introducible into the tube in a tight fitting manner to minimize or eliminate free movement of the tube along the cable of the cable lock.

The modified pad lock is attachable to the portable objects that need to be prevented from being removed. The modified pad lock is also connectable to a cable lock to secure the portable objects from being removed. The locking clamp of the modified pad lock is selected from group consisting a rod, chain, strap, string, tape and cord. The chain, strap, string, tape and cord are retractable and lockable permanently or temporarily in several positions to provide desired of the chain, strap, string, tape and cord. The modified pad lock includes locks that are selected from group consisting number lock, combination lock, key lock, finger print sensing lock and smart card lock.

The modified wire-tie includes at least one locking hole on its body or as an extension. The locking hole on the modified wire-tie allows insertion of the locking tongue of the cable lock. Therefore an article secured with a modified wire-tie can be further secured to a stationary object by inserting the locking tongue of the cable lock in the locking hole of the modified wire-tie. The modified wire-tie also used to add locking holes on cable lock, modified pad lock, conventional pad lock, any portable articles including PDA and mobile phones.

The present invention also relates to modification of cable lock adaptor. The invention particularly relates to cable lock adaptor extension cord. The extension cord comprising a lock adaptor connected or fused at one terminal end of at least one flexible elongate member and a lock head with locking tongue at other terminal end of the respective flexible elongate member. The lock head with locking tongue of the elongate member extension cord is connectable to the means of receiving locking tongue on an object. The other modification relates cable lock adaptor extension cord comprising a lock head with locking tongue connected or fused at one terminal end of the elongate member and another lock head with locking tongue at the other end of the terminal end of the elongate member. Both cable lock adaptor extension cords optionally includes at least one lock adaptor.

The present invention further includes modifications of cable lock adaptor. A flexible elongate member comprising one lock adaptor at one terminal end of the elongate member and the other terminal end of the elongate member includes at least two branches of flexible elongate members connected to at least two lock heads at the terminal ends of the respective flexible elongate members. Another modification includes a flexible elongate member comprising a loop at one terminal end of the flexible elongate member and the other end of the flexible elongate member branches to at least two flexible elongate members with each terminal end connected to locking head. These two extension cord also optionally includes at least one lock adaptor.

The next modification is done to the cable of the cable lock. The modification of the cable of the cable lock relates to a flexible elongate member attached with locking hole along its body. At one end of the elongate member is attached with a lock head and the other end is a loop or has a means to form a loop like structure. A loop like structure is formed by introducing lock tongue onto means to receive the lock tongue positioned in a housing body and wherein optionally the housing body includes means to receive the flexible elongate member. Besides that a loop like structure is also formed by using a flexible elongate member at one end of which is attached to a lock head with locking tongue and the other end of the flexible elongate member is also attached with another lock head. The loop like structure is formed by introducing the lock head with locking tongue at one end onto means to receive the locking tongue positioned along the flexible elongate member.

Finally the present invention relates to a power security system. The cable of the cable lock, housing of retractable cable and lock adaptors are incorporated with sensing and alarm means. The sensing and alarm means are triggered when the cable lock is tampered. The cable of the cable lock, housing and lock adaptor further includes an indicator light to warn that the security system is under surveillance.

### BRIEF DESCRIPTION OF THE DRAWINGS

The present invention will become more fully understood from the detailed description given herein below and accompanying drawings which are given by way of illustration only, and thus are not limitative of the present invention, wherein:

FIG. 1 shows a diagrammatic view of a locked suitcase by using a cable lock with lock adaptor.

FIG. 2 shows a diagrammatic view of a cable lock adaptor used to secure multiple suitcases.

FIGS. 3a-3h shows a diagrammatic view of various types of tube as a lock adaptor.

FIGS. 3i and 3j shows a diagrammatic view of a plate as a lock adaptor.

FIGS. 3k and 3l shows a diagrammatic view of various types of plate as a lock adaptor.

FIGS. 3m-3o shows a diagrammatic view of different types of rings as a lock adaptor.

FIGS. 3p and 3q shows a diagrammatic view of discs as a lock adaptor.

FIG. 3r shows a diagrammatic view of a modified pad lock with locking hole on the pad lock.

FIGS. 3s-3u a diagrammatic view of three types of modified wire-tie or cable tie.

FIGS. 4a-4c shows a diagrammatic view of various types of cable lock adaptor extension cord (at one end flexible elongate member is fused/attached/connected to a lock adaptor and the other end is a lock head).

FIG. 4d shows a diagrammatic view of a cable lock extension cord with a lock adaptor on the cable.

FIG. 4e shows a diagrammatic view of the use of the cable lock adaptor extension cord described in FIG. 4b.

FIGS. 5a-5c shows a diagrammatic view of various types of cable lock adaptor extension cord (at one end of flexible elongate member is connected with lock head and the other end also connected with lock head and the flexible elongate member optionally include at least one lock adaptor.

FIG. 5d shows a diagrammatic view of the use of the cable lock adaptor extension cord described in FIG. 5c.

FIG. 6 shows a diagrammatic view of a cable lock adaptor extension cord with two branches of lock head at one end and the other end is a lock adaptor.

FIG. 6a shows a diagrammatic view of the use of the branched cable lock adaptor extension cord of FIG. 6.

FIG. 7 shows a diagrammatic view of a cable lock adaptor extension cord with two branches of lock heads at one end and the other is a loop means.

FIG. 7a shows a diagrammatic view of the use of the cable lock adaptor extension cord of FIG. 7 and FIG. 5c.

FIG. 8 shows a diagrammatic view of a cable of a cable lock with at least one locking hole along its body.

FIG. 8a shows a diagrammatic view of a cable of a cable lock with locking holes on the cable and the lock head at the end can form a loop like structure and the other lock head and locking hole to secure the object.

FIG. 8b shows the diagrammatic view to show how the hole in the housing can be used to lock the object to secure.

FIGS. 9 and 9a shows a diagrammatic view of a modified pad lock with one lock adaptor on its lock clamp.

FIG. 9b shows a diagrammatic view of a modified pad lock attached to a portable object and use of the modified pad lock and a cable lock to secure the portable object.

FIG. 9c shows a diagrammatic view of a modified pad lock used with a cable lock to provide a locking hole on the cable lock.

FIG. 9d shows a diagrammatic view of an extendable and retractable locking clamp in a coiled position attached to the modified pad lock.

FIGS. 10a and 10b shows a diagrammatic view of modified wire-tie with locking hole on its body and a modified wire-tie with an extension locking hole respectively.

FIG. 10c shows a diagrammatic view of modified wire-tie and cable lock to further secure the portable object.

### DETAILED DESCRIPTION OF A PREFERRED EMBODIMENT OF THE INVENTION

The present invention relates to an apparatus to use on or with a cable lock (12) to lock and prevent removal of any portable articles (44) from a location where the articles is placed. The preferred embodiment relates to a lock adaptor (10) to use on or with a cable lock (12). The invention also relates the use of cable lock adaptor extension cords (50) and power security system for cable housing (58), cable (14) and lock adaptors (10) for additional security.

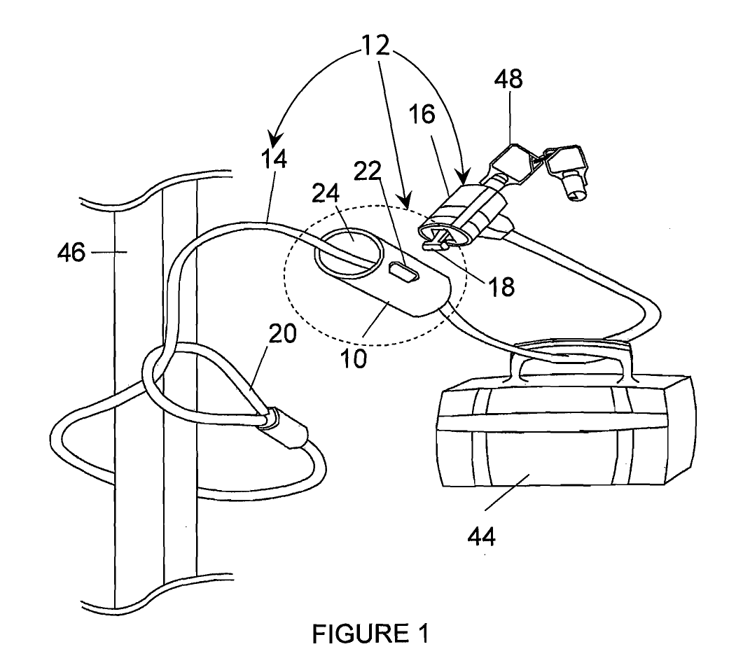

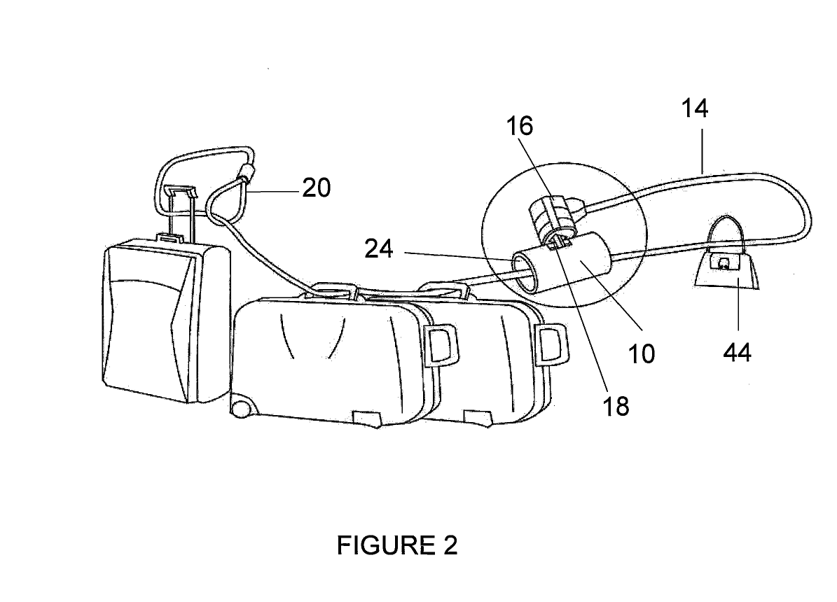

The preferred embodiment describes a cable lock adaptor (10). Cable lock (12) is a cable (14) with a locking head (16) at one end of a cable (14) and a loop (20) or means to form loop like structure. The locking head (16) is attached with a locking tongue (18). The cable lock adaptor (10) is a cable lock accessory that can be inserted through one end of cable lock (12) (preferably over a loop (20) or means to form a loop like structure), if the cable lock (12) has already been made. The lock adaptor (10) is also introducible in manufacturing process by sliding on to the cable (14) before making the loop (20) or loop means or attaching locking head (16) to the cable (14). A suitcase is lockable by using the lock adaptor (10) with the cable lock (12) as shown in FIG. 1. The lock adaptor (10) is moveable or slideable along the cable (14) of the cable lock (12) from the loop (20) to the lock head (16) freely so that there is no minimum or maximum limit for any size of article that needs to be secured. This will help to lock multiple articles (for example, to lock few suitcases together by handles as shown in FIG. 2) even without the need of a stationary object (46). The lock adaptor is firmly or loosely connectable to the portable article. The lock adaptor (10) is rotateable on the cable (14) thus minimizing kinking of the cable (14). The cable (14) can be of any flexible elongate member selected from a group consisting of cable, rod, chain, tape, string, cord and strap or combinations of these. The lock adaptor (10) is fuseable, attachable or connectable to the cable lock (12). The cable (14) or the body of the cable lock (12) optionally includes at least one locking hole (22) anywhere along its body or an attachment on its body.

The lock adaptor (10) has at least one locking hole (22) and one means to receive the cable (14) of the cable lock (12). The locking hole (22) is fuseable, attachable or connectable to the lock adaptor. Therefore the locking hole is either spaced apart from the lock adaptor (10) or inherent to the lock adaptor (10). The locking hole (22) is described as a means to receive the locking tongue (18). Examples of locking hole (22) are such as bore, chamber, wedge, groove and slit of different sizes and shapes. The locking hole (22) is not restricted to the examples mentioned above but it can be of any opening that functions as a means to receive the locking tongue (18). Examples of two different locking holes (22) are described herein. For the bore, the locking tongue (18) of the lock head (16) is introduced into the bore in an open position and wherein the locking tongue (18) is alignable in a locking position within the bore by the use of key means (48) or other means to allow the locking tongue (18) in a locked position. The chamber comprises of a first hollow chamber and second hollow chamber. In the case of chamber, the locking tongue (18) is introduced into the first hollow in an open position and then the locking tongue (18) is alignable in a locking position within the second hollow chamber by the use of key means (48) or other means to keep the locking tongue (18) in a locked position.

The lock head (16) comprises of a means to receive key means (48) at one end of the lock head (16) and a locking tongue (18) attached to the other end of the lock head (16). The locking tongue (18) attached to the lock head (16) is described as a means to be fitted and locked in a position in the locking hole (22) by the use of key means (48) or other means (e.g. twisting the lock head or lock means such as number lock to a lock position) to allow the locking tongue (18) in a locked position. Examples of the locking tongue (18) are such as tongue, hook, lever arrangement, pair of feet etc. Each said foot having a hook head projecting in opposite directions. The foot is introduced and aligned in a locked position in the locking hole (22) or locking holes. The locking tongue (18) is not restricted to the examples mentioned above but it can be of any means that functions as a locking hole (22) attachment which needs to be fitted and locked in a lock position in the locking holes (22). The size and shape of the locking hole (22) is varied to fit any locking tongue (18) of lock heads (16) available on the same lock adaptor (10) making it a universal adaptor. A universal adaptor is also a unit where the adaptor (10) comprises of plurality of locking holes (22) on the same adaptor to lock several cable locks (12) or to create a loop using cable (14) with double locking head (16) or cable lock adaptor extension cord (50).

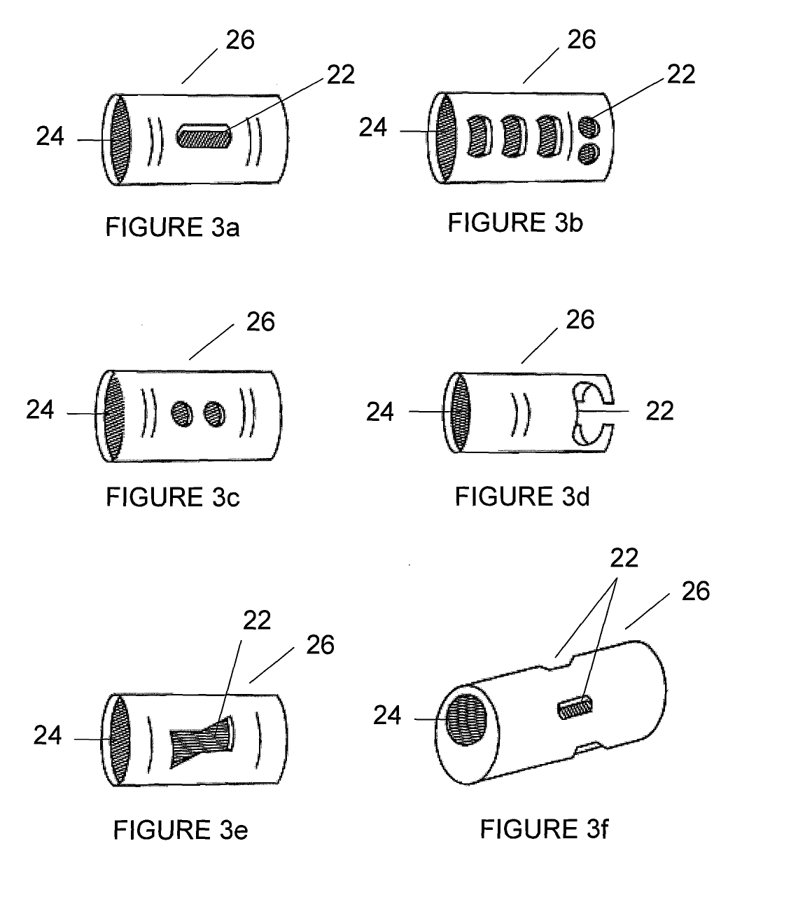

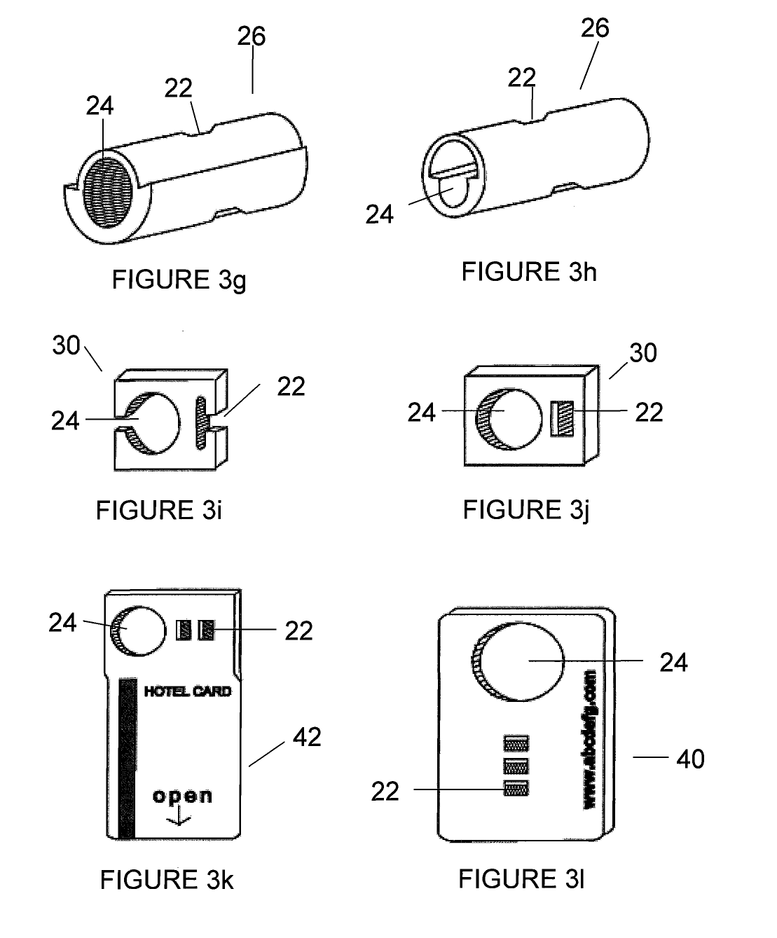

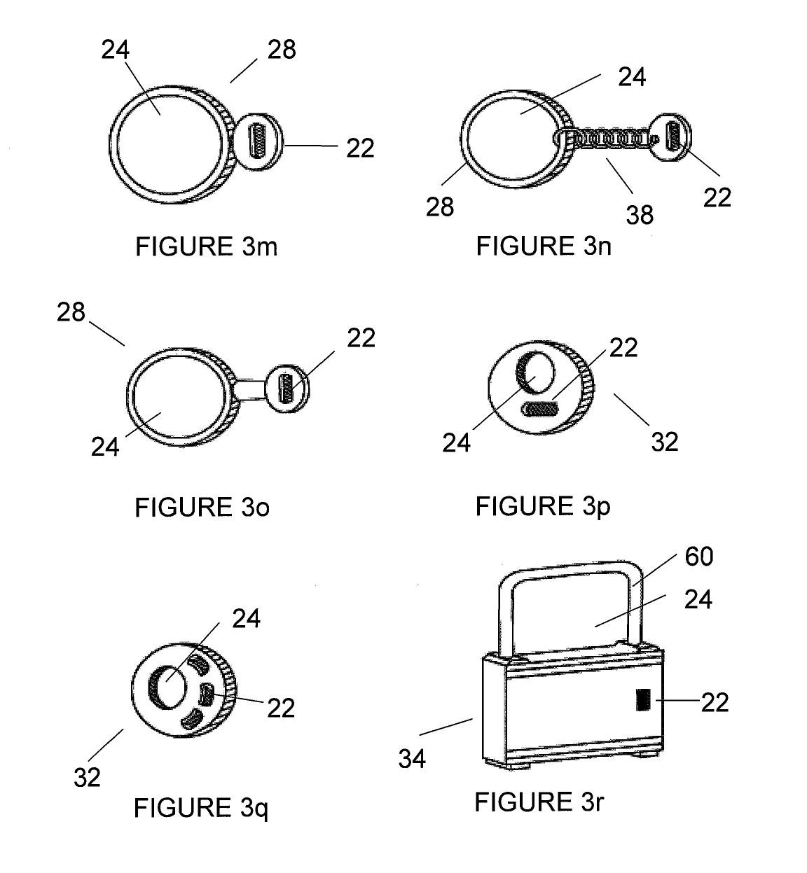

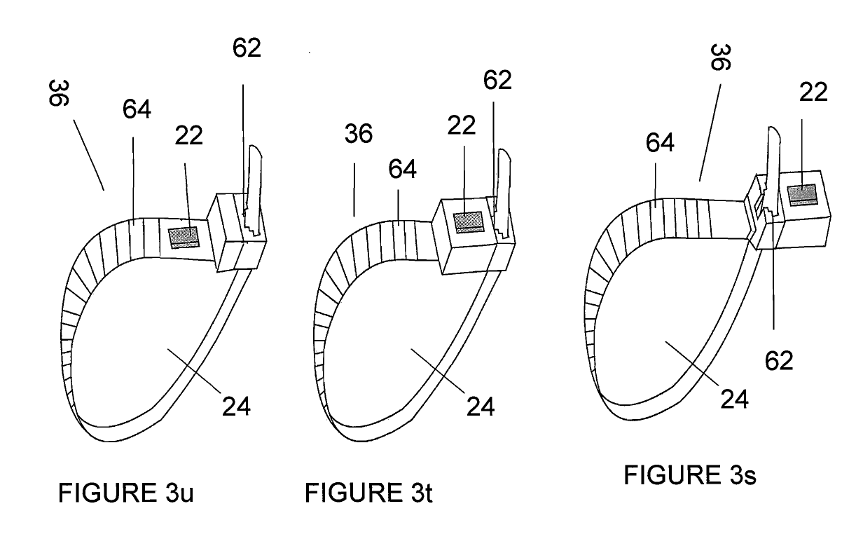

The lock adaptor (10) is selected from a group comprising tube (26) as shown in FIGS. 3a-3h, plates (30) as shown in FIGS. 3i-3l, ring (28) as shown in FIGS. 3m-3o, disc (32) as shown in FIGS. 3p and 3q, modified padlock (34) as shown in FIG. 3r and modified wire tie (36) as shown in FIG. 3s to 3u. The lock adaptors (10) are not limited to the examples given above, but to any article, any single piece, fused pieces or connected pieces that comprises of at least one locking hole (22) and a means to receive the cable (14) of the cable lock.

The lock adaptor (10) is made from materials such as metals, non-metals, metalloids, alloys, synthetic materials such as polymers, plastic, resin, polyester, polyethene, poly carbonate, poly vinyl and nylon, cloth, wood, leather, bone, rock, marble, quartz, ceramic, fiber glass, glass and combinations of two or more of any materials mentioned above. Thickness of the lock adaptor (10) changes to handle lock heads (16) of various lengths for lock tongue (18). Insert elements are optionally placed inside the lock adaptor (10) (the lock adaptor mentioned herein is referred to tube (26)) to minimize or eliminate free movement of the lock adaptor (10). A groove or a gap is preferably made in the insert element to allow free movement of the locking tongue (18). Bubble trap on the cable (14) of the cable lock (12) can also minimize this free movement.

The lock adaptor (10) preferably personalized with name, company name, logo, phone numbers, e-mail address, URL, etc. This will allow the user to personalize not only the lock adaptor, but also their belonging such as computer bag, suitcase etc. The personalization can be done by different methods such as engraving, laser, painting, printing and pasting.

The present invention further describes a tube (26), ring (28), plate (30) and disk (32). The inner diameter of the tube (26) to be inserted on to the cable (14) of the cable lock (12) should be slightly than thickest part of loop (20) junction/joint, if the cable lock (12) has already been made. If the tube (26) is inserted before the construction of the loop (20) or attaching the lock head (16) (in the manufacturing process), the diameter of the tube (26) is decreased. At least one insert member is introducible into the tube (26) to minimize or eliminate free movement of the tube (26) along the cable (14) of the cable lock (12). As for the ring (28), it is used with the cable lock (12) when needed to lock and secure any portable objects (44). Besides that the ring (28) can be worn in fingers or toes as an ornament, or as a part of necklace and bangle. It can also be modified as key chains (38) and similar. Examples of plate (30) that can be used as lock adaptor (10) are such as keys, coins, luggage tags (40) and hotel room card keys (42) or similar.

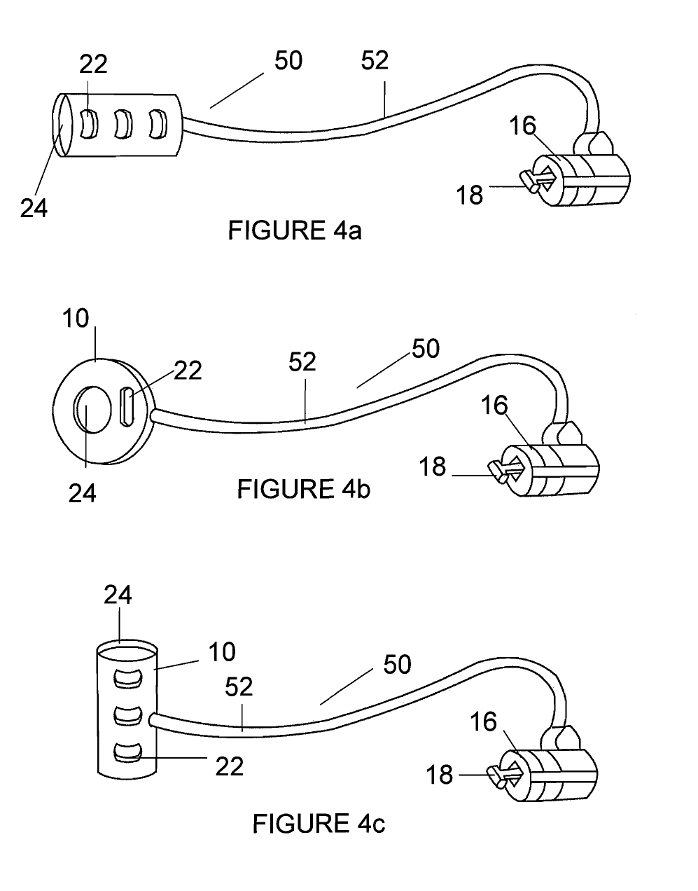

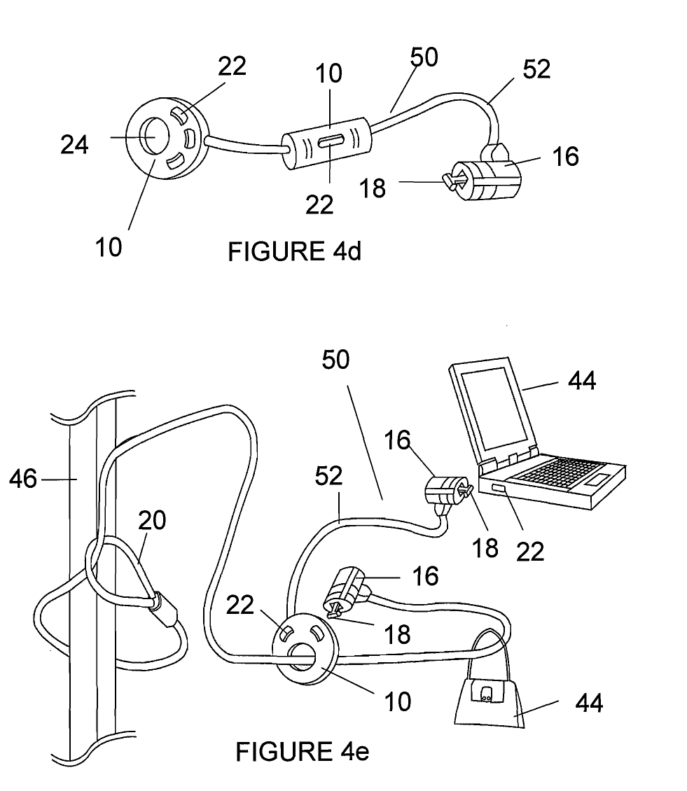

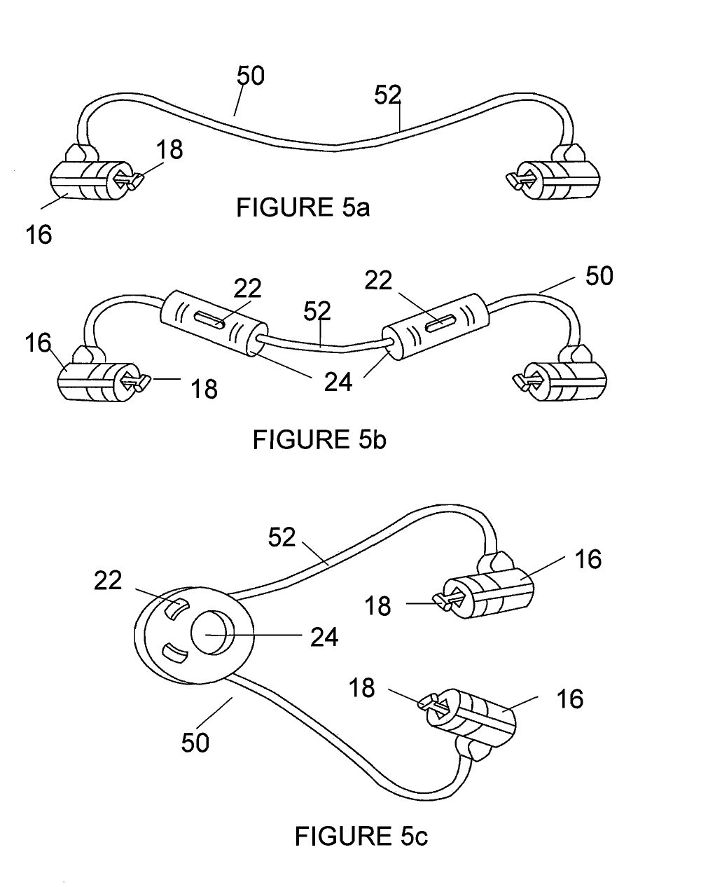

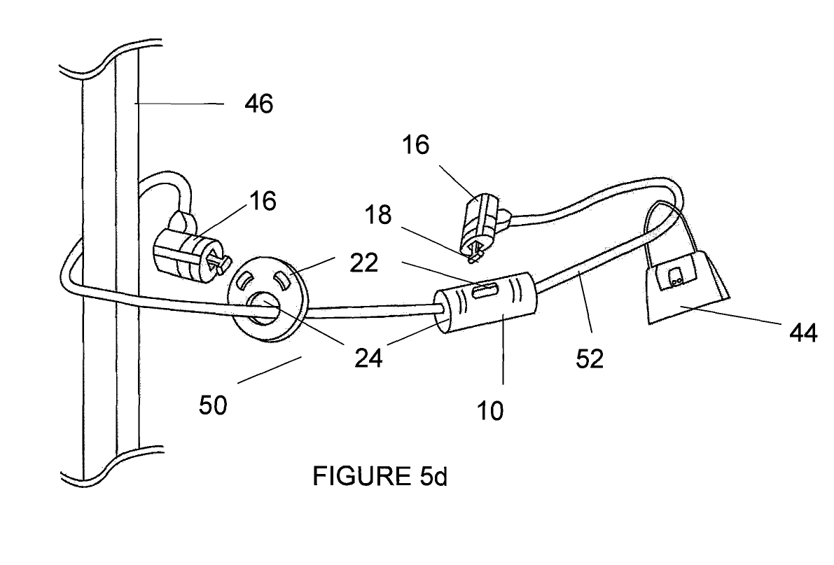

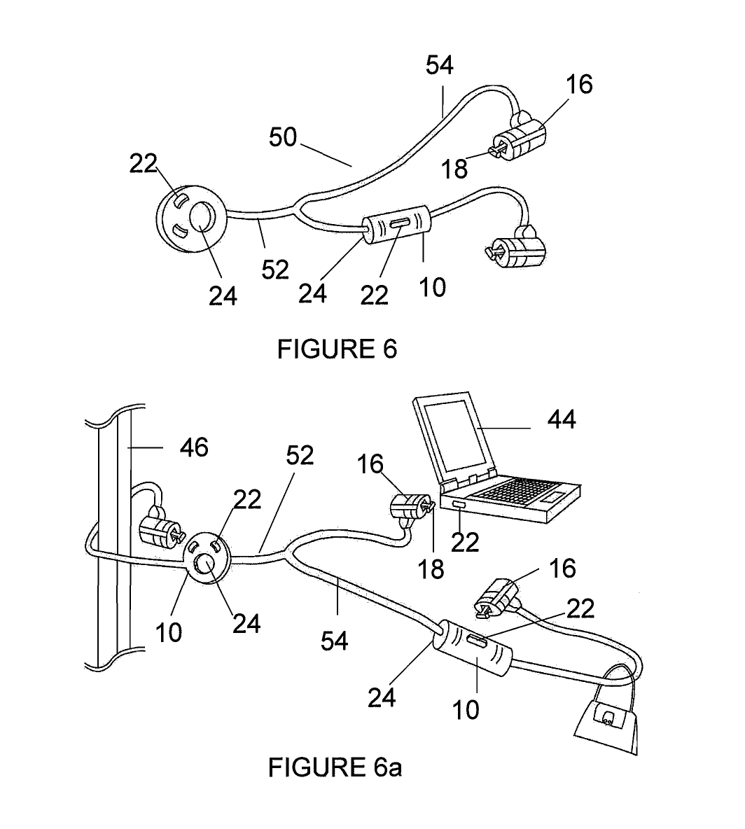

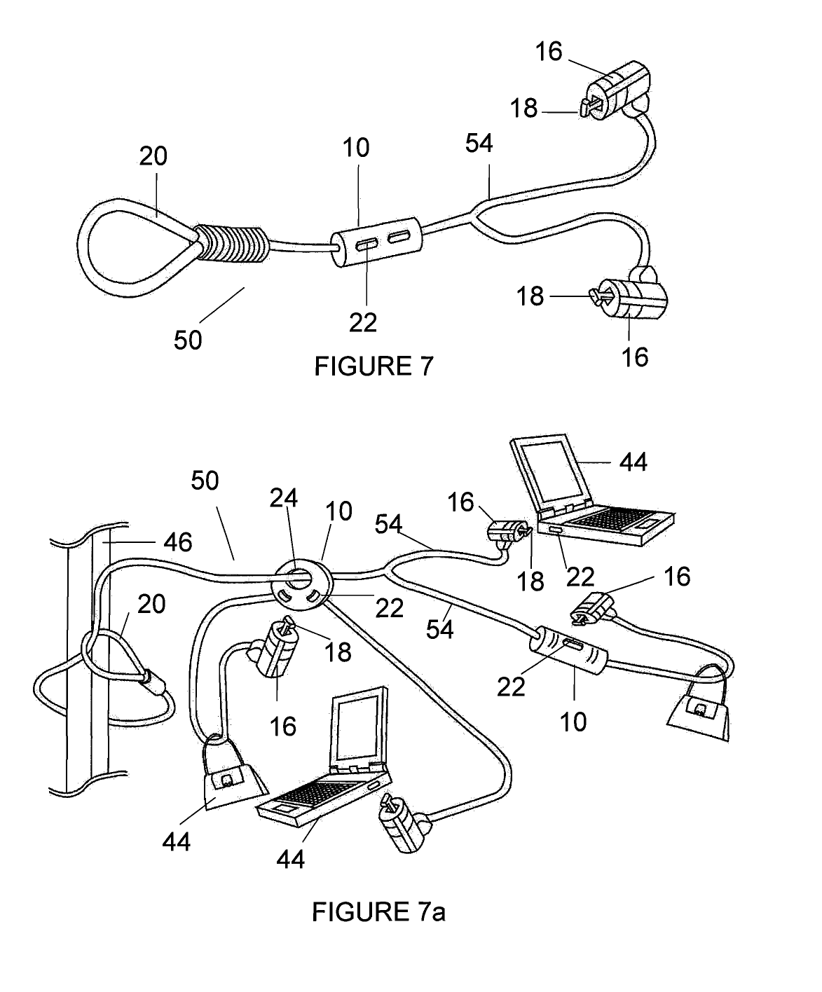

The present invention also relates to modifications of cable lock adapter (10) are described herein. The modification of cable lock adapter is referred to cable lock adaptor extension cords (50). The cable lock adaptor extension cords (50) comprising:
i) a lock adaptor (10) connected or fused or attached to at least one terminal end of at least one flexible elongate member (52) and a lock head (16) at the other terminal end of the respective flexible elongate member (52) as shown in FIGS. 4a-4c. The flexible elongate member (52) optionally includes at least one lock adaptor (10) as shown in FIG. 4d. The lock adaptor (10) is connectable with one or more lock heads (16) to lock multiple portable articles (44). The lock head (16) with locking tongue (18) is also connectable to locking hole (22) attached to an article (44) as shown in FIG. 4e.
ii) a lock head (16) connected at one terminal end of a flexible elongate member (52) and another lock head (16) connected to the other terminal end of the flexible elongate member (52) and optionally includes at least one lock adaptor (10) as shown in FIGS. 5a-5c. This cable lock adaptor extension cord (50) with one lock adaptor (10) fused to the flexible elongate member (52) and another lock adaptor (10) inserted in to the flexible elongate member (52) is used to secure a bag (44) as shown in FIG. 5d. Here when one of the locking head (16) when connected to the lock adapter (10) can form a loop like structure.
iii) a flexible elongate member (52) branches to at least two secondary flexible elongate members (54) with at least two lock heads (16) connected at the terminal end of the respective flexible elongate member (54) and the other end of the flexible elongate member (52) is connected to a lock adaptor (10) and the flexible elongate member optionally includes at least one lock adaptor (10) as shown in FIG. 6. The use of this cable lock adaptor extension cord (50) is shown in FIG. 6a. FIG. 7a also illustrates the use of a cable lock extension cord (50) as shown in FIG. 5c.
iv) a flexible elongate member (52) branches to at least two secondary flexible elongate members (54) with at least two lock heads (16) connected at the terminal end of the respective flexible elongate member (54) and the other end of the flexible elongate member (52) is a loop (20) and the flexible elongate member optionally includes at least one lock adaptor as shown in FIG. 7. The use of this cable lock adaptor extension cord is shown in FIG. 7a.

The cable lock adaptor extension cord (50) described above is optionally partly or fully in housing. The flexible elongate member (52, 54) is selected from a group consisting of cable, rod, chain, tape, cord or combinations of these. The cable lock adaptor extension cords (50) are also retractable and extendable according to length required.

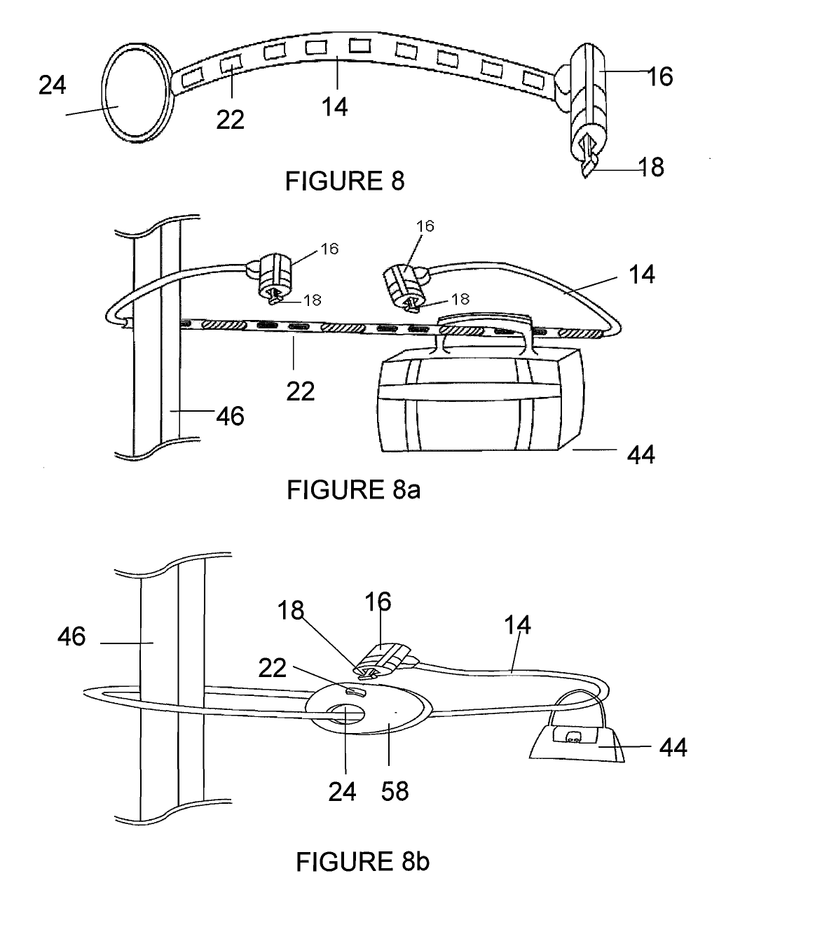

Besides having modification to the cable lock adaptor (10), the cable (14) of the cable lock (12) is also modified into few types. The modification relates to a cable (14) of the cable lock (12) attached with at least one locking hole (22) along its body. The cable (14) of the cable lock (12) can be of any flexible elongate member selected from a group consisting of cable, rod, chain, tape, cord or combinations of these. At one end of the cable lock (12) is attached with a lock head (16) and the other end is a loop (20), or a means to form loop like structure as shown in FIGS. 8 and 8a. Examples of means to form loop like structure is further described. In the first example, the cable can be inserted through the ring to form a loop like structure and the lock head (16) can be looped around the object to be secured (44). The lock tongue (18) can be received on any of the locking hole (22) on the cable shown in FIG. 8. Second example relates to a cable (14) at one end of which is attached to a lock head (16) with locking tongue (18) and the other of the cable (14) is attached with another lock head (16). A loop like structure is formed by introducing the lock head (16) with locking tongue (18) at one end onto means to receive the locking tongue (18) positioned along the cable (14). The third example relates to a loop like structure formed by introducing the locking tongue (18) onto means to receive locking tongue (18) positioned in a housing body (58) and wherein optionally the housing body (58) includes a means to receive the cable (24) as shown in FIG. 8b. The cable (14) is extendable and retractable within the housing (58). Therefore the cable (14) is extendable and retractable depending on flexibility and distance of an article (44) that needs to protected.

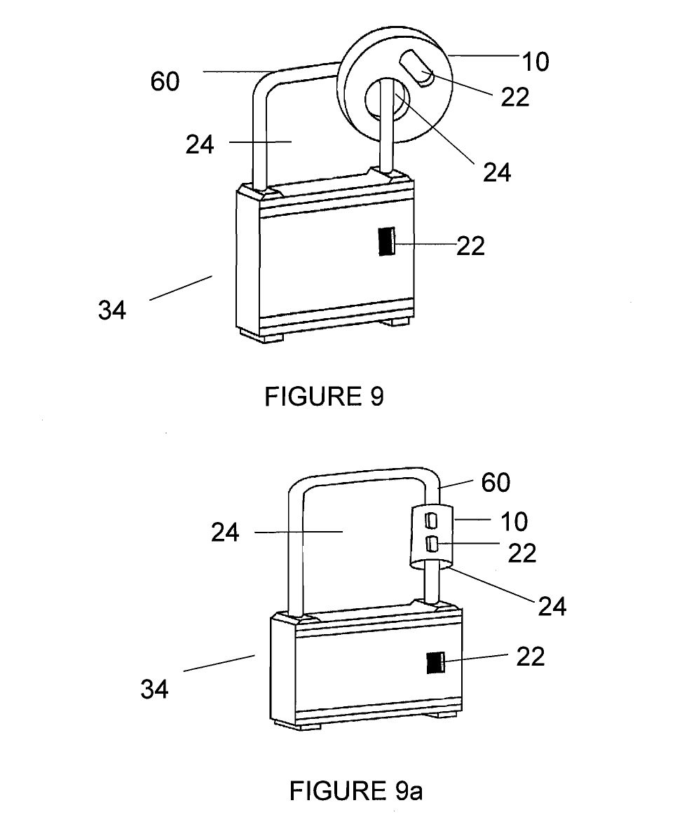

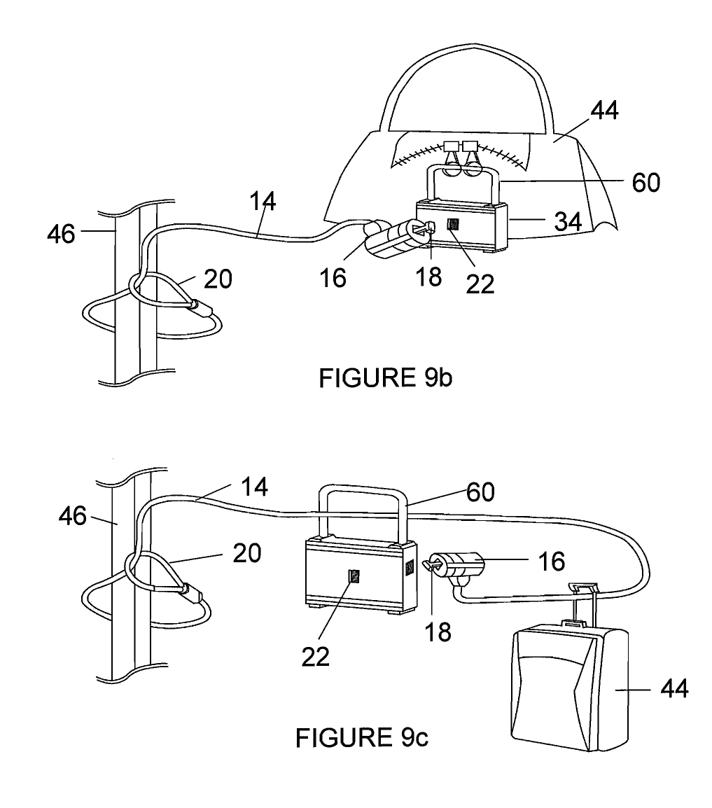

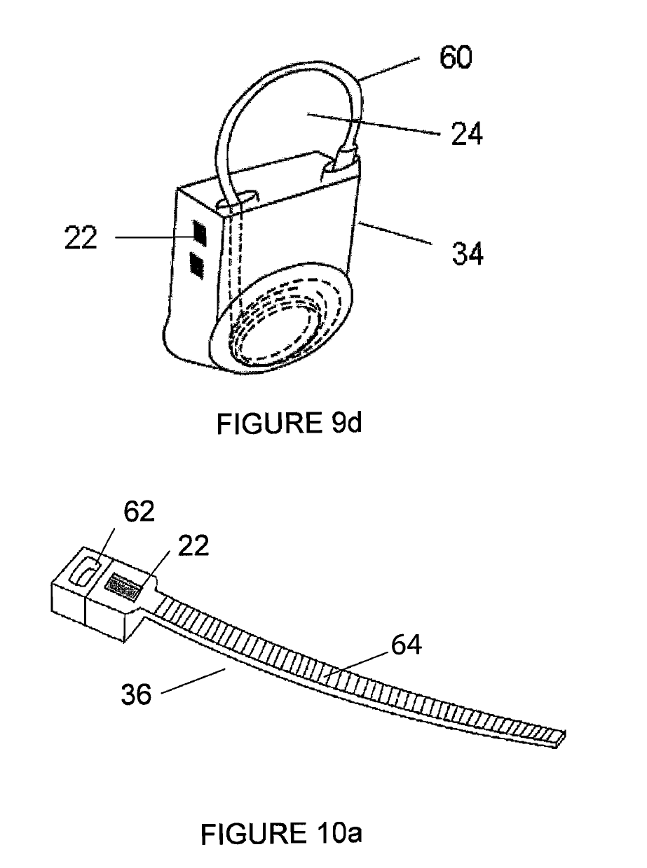

A modified pad lock (34) is a locking device similar to conventional padlock, but modified with at least one locking hole (22) attached or fused or made on its body (34) or on its lock clamp (60) as shown in FIG. 3r. One or several of lock adaptors (10) is insertable on a locking clamp (60) of the modified pad lock (34) (as shown in FIGS. 9 and 9a)/conventional pad lock or fused or connected with the modified padlock (34)/conventional pad lock, to convert it into a universal locking tool. The modified padlock (34) is attached on portable articles that need to be protected and also useable as a means to receive locking tongue (22) of the lock head (16) from the cable lock (12) as shown in FIG. 9b. The modified pad lock (34) is permanently or temporarily attachable to the cable (14) of the cable lock (12) as shown in FIG. 9c. The cable lock (12) is also used to lock portable articles (44) that are secured with lock adaptor (10)—conventional pad lock combination or the lock adaptor (10)—modified padlock (34) combination.

The modified padlock (34) contains at least one locking hole (22) that can be of any size and shape to accommodate a variety of locking tongues (18) attached to the lock heads (16). The locking clamp (60) on the modified pad lock (34) can be of different size, shape and flexibility to allow locking of bulky objects, or different zippers of a back pack and computer bag. The locking-clamp (60) is made of a rod, chain, cable, tape, strap, string, cord or combinations of them. The locking clamp (60) is optionally extendable and retractable and kept further in a coiled position attached to the modified pad lock (34) as shown in FIG. 9d. The locking clamp (60) is adjustable and lockable permanently or temporarily in several positions to provide desired length. Lock of the modified pad lock (34) is selected from group consisting of number lock, combination lock, key lock, finger print sensing lock, smart card (consist of personal details) lock and a one time lock (cannot open once it is locked).

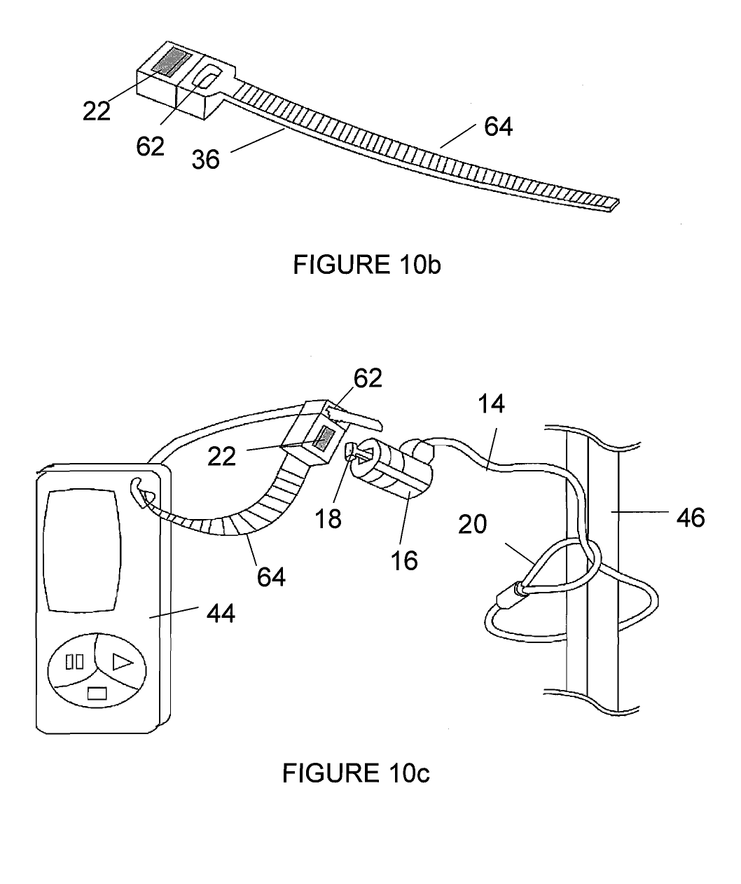

Wire-tie is a self locking plastic wire-tie comprises of a unitary locking (62) mechanism attached to a strip of scored lines (64). The wire tie is used to wrap around an article and the strap with scored lines (64) is inserted into the unitary locking mechanism (62) to secure the article (44). The wire tie is modified to include at least one locking hole (22) (FIGS. 10a and 10b) on its body or as an extension, which can be used as a lock adaptor (10) as shown in FIG. 10c. Wire-ties are cheap and are used widely. They are made with strong materials. An article (44) secured with a modified wire-tie (36) can be further secured to a stationary object (46) by inserting the locking tongue (18) of the cable lock (12) in the locking hole (22) of the modified wire-tie (36) as shown in FIG. 10c. The wire-ties can also be used to add means to receive locking tongue (22) onto cable lock (12), modified pad lock (34), conventional pad lock, any portable articles (44) including PDA and mobile phones.

Power security cables known for computer cable lock are powered by CPU or external power. In the present invention, the power security is also incorporated in a cable (14) of the cable lock (12) and lock adaptor (10) (example: tube (26)) wherein the lock adaptor (10) and the cable (14) has battery, sensors and indicators (speaker, flash lights) and means to power the cable (14) of the cable lock (12). This will help to sound an alarm, flash or turn on light, trigger a message, automatically send SMS, or give a call to authorized personal when the cable lock (12) is tampered. The same application is also applicable in the housing (58) of the cable (14) of the cable lock (12) where the housing (58) has a cell or battery and means to power the cable (14) of cable lock (12). This will help to sound an alarm, flash or turn on light, trigger a message, automatically send SMS, or give a call to authorized personal when the cable lock (12) is tampered. An indicator light warning is also incorporated on the cable (14), lock adapter (10), housing (58) or lock to warn that the cable lock (12) is under surveillance. Means to power the cable (14) is a known to art and will not be described herein.

Making a means to receive locking tongue (18) on any articles (suitcases, bags, helmets, dog's belt, portable instruments, displayed objects, and other portable articles) (44) allows one to lock it using a cable lock (12). If materials such as metal, cloth, tape, leather, plastics, and polymers need a locking hole (14), it can be punched with locking holes (22) similar to holes made on a waist belt, but in different shapes as required to insert the locking tongue (18) of the cable lock (12). The holes made on leather, cloth, resin, plastic may be weak. Therefore the holes are reinforced to provide strength to the holes (22) which later allows the holes on leather, cloth, resin, plastic articles lockable with a cable lock (12). Reinforcing is done on edges of the holes (22) or by adding a support material such as metal, polymers, and ceramics.

The foregoing description of the preferred embodiments of the invention has been presented for the purpose of illustration and description, rather than limitation. The preferred embodiments of this invention have been disclosed, however, various changes may be made without departing from the principles and scope of the invention.

1. (canceled)

2. An apparatus as claimed in claim 47 wherein the flexible elongated member is selected from a group consisting cable, chain, tape, rod, cord, string and strap or combination thereof.

3. An apparatus as claimed in claim 44 the flexible elongate member includes at least one means to receive locking tongue anywhere along its body or an attachment on its body.

4. An apparatus as claimed in claim 44 wherein the lock adaptor is selected from a group consisting tube, ring, plate, disc, modified pad lock and modified wire-tie wherein the modified pad lock includes at least one means to receive locking tongue made or fused either on its body or on its locking clamp and wherein the modified wire tie includes one means to receive locking tongue attached or fused or connected to the wire-tie.

5. (canceled)

6. An apparatus as claimed in claim 47 wherein the means of receiving the locking tongue is selected from a group consisting of a bore chamber, wedge, groove and slit.

7. An apparatus for securing portable objects as claimed in claim 6 wherein the chamber comprises of first chamber and second hollow chamber wherein the locking tongue is introduced into the first chamber in an open position and wherein the locking tongue is alignable in a locking position within the second hollow chamber by the use of a key means or other means to allow the locking tongue in a locked position.

8. An apparatus for securing portable objects as claimed in claim 6 wherein the means to receive the locking tongue comprises a bore wherein the locking tongue is introduced into the bore in an open position and wherein the locking tongue is alignable in a locking position within the bore by the use of a key means or other means accessible from outside of said locking adapter to allow the locking tongue in a locked position.

9-12. (canceled)

13. An apparatus as claimed in claim 44 wherein said flexible elongated member includes said lock head with locking tongue at one end and a loop means or has a means to form a loop structure at the other end wherein the lock adaptor includes at least one means to receive the locking tongue and a means to receive the flexible elongate member therethrough.

14. An apparatus claimed in claim 13 wherein the lock adaptor includes plurality of means to receive locking tongues having different shapes and sizes to accommodate different lengths of locking tongues.

15. An apparatus claimed in claim 13 wherein the lock adaptor is introducible onto a locking clamp or fused or connected to a conventional pad lock or modified pad lock.

16-43. (canceled)

44. An apparatus for securing portable objects comprising:
a flexible elongated member;
a lock head having a locking tongue attached to said elongate member; and
a lock adapter attached to said elongated member having a receiving means with an opening to receive said locking tongue of said locking head.

45. An apparatus as claimed in claim 44 wherein said lock adapter is a body having an opening through which said elongate member passes to permit said locking adapter to be moved along said elongated member.

46. An apparatus as claimed in claim 44 wherein said lock adapter is fixedly attached to said elongate member

47. An apparatus as for securing portable objects comprising:
a flexible elongated member;
a lock head having a locking tongue attached to said elongated member; and
a lock adaptor comprising a tubular body having at least one receiving means to receive said locking tongue of said lock head accessible from a surface of the tubular body and an opening through which said flexible elongated member passes to permit said locking adapter to be moved along the length of said elongated member.

48. An apparatus as claimed in claim 45 wherein said locking adapter comprises a planar body having at least one receiving means to receive said locking tongue of said lock head disposed on a surface of the planar body and said receiving means to receive a flexible elongated member therethrough.

49. An apparatus as claimed in claim 45 wherein said locking adapter comprises:
a ring body having a receiving means to receive said flexible elongate member and at least one receiving means attached or fused to a surface of the ring body to receive said locking tongue of said lock head.

50. An apparatus as claimed in claim 45 wherein said locking adapter comprises:
a modified pad lock having a locking adaptor end including at least one receiving means made or fused or slidable either on its body or on its locking clamp to receive said locking tongue of said lock head.

51. An apparatus as claimed in claim 45 wherein said locking adapter compnses:
a modified wire tie including at least one receiving means made, attached or fused or connected to the wire tie to receive said locking tongue of said lock head.

52-54. (canceled)

55. Apparatus as claimed in claim 44 wherein said receiving means to receive the locking tongue is spaced apart from the lock adaptor.

56. Apparatus as claimed in claim 47 further comprising at least one insert member that is introducible into the tubular body in a tight fitting manner to minimize or eliminate free movement of the tubular body along the flexible elongate member and wherein the tubular body can be positioned anywhere along the flexible member.

57. Apparatus as claimed in claim 46 further comprising a flexible elongate member lock adaptor extension cord comprising a lock adaptor connected or fused at one terminal end of at least one flexible elongate member and a lock head with locking tongue at the other terminal end of the at least one flexible elongate member and the flexible elongate member optionally includes at least one lock adaptor.

58. Apparatus as claimed in claim 57 wherein the lock head with locking tongue of the flexible elongate member lock adaptor extension cord is connectable to the means of receiving the locking tongue attached on portable articles.

59. Apparatus as claimed in claim 58 wherein the lock adaptor is connected with one or more lock heads to lock multiple portable objects.

60. Apparatus as claimed in claim 47 further comprising a flexible elongated member lock adaptor extension cord comprising a lock head with locking tongue connected or fused at one terminal end of the elongated member and another lock head at the other terminal end of the elongated member and the flexible elongated member optionally includes at least one lock adaptor.

61. Apparatus as claimed in claim 57 wherein said flexible elongated member extension cord is retractable according to length required.

62. Apparatus as claimed in claim 60 wherein the flexible elongated member extension cord is retractable according to length required.

63. Apparatus as claimed in claim 47 and further comprising a flexible elongated member lock adaptor extension cord comprising one lock adaptor at one terminal end of a elongated member and the other terminal end of the elongated member includes at least two branches of flexible elongate members connected to at least two lock heads at the terminal ends of the respective flexible elongate members and the flexible elongate member optionally includes at least one lock adaptor.

64. Apparatus as claimed in claim 44 and further comprising a flexible elongated member lock adaptor extension cord comprising a loop or a loop forming structure at one terminal end of a flexible elongated member and the other end of the flexible elongated member includes at least two branches of flexible elongated members with each terminal end connected to locking head and the flexible elongated member optionally includes at least one lock adaptor.

65. Apparatus as claimed in claim 50 wherein the modified pad lock comprises at least one lock adaptor introducible onto a locking clamp or fusable or connectable or attachable to the conventional or modified pad lock.

66. Apparatus as claimed in claim 44 wherein said lock adaptor is introducible onto a locking clamp or fused or connected to a conventional pad lock or modified pad lock.

67. (canceled)

68. Apparatus as claimed in claim 67 wherein the cable, chain, strap, string, tape or cord are retractable and optionally lockable permanently or temporarily in several positions to provide desired length.

69. Apparatus as claimed in claim 50 wherein said modified pad lock includes locks that are selected from group consisting of a number lock, combination lock, key lock, finger print sensing lock and smart card lock.

70. Apparatus as claimed in claim 51 wherein the said modified wire tie is attachable to the portable objects that need to be prevented from being removed.

71. Apparatus as claimed in claim 51 wherein the locking tongue of the lock head attached to one end of the flexible elongate member is fitted into a means to receive locking tongue attached to the modified wire tie.

72. Apparatus as claimed in claim 71 wherein the modified wire tie is attachable to portable objects that need to be secured.

73. Apparatus as claimed in claim 44 wherein said flexible elongated member includes sensing and alarm means.

74. Apparatus as claimed in claim 74 wherein said lock adaptor is included with sensing and alarm means.

75. Apparatus as claimed in claim 73 wherein the sensing and alarm means is triggered when the flexible elongated member is tampered.

76. Apparatus as claimed in claim 74 wherein the sensing and alarm means is triggered when the flexible elongated member is tampered.

77. Apparatus as claimed in claim 44 wherein the flexible elongated member or lock adaptor further includes an indicator light to warn that the flexible elongate member is under surveillance.

78. Apparatus as claimed in claim 44 wherein the lock adaptor is fused to the flexible elongate member.

79. Apparatus as claimed in claim 78 wherein the flexible elongated member includes at least one means to receive locking tongue anywhere along its body or an attachment on its body.

80. Apparatus as claimed in claim 47 wherein the lock adaptor is a body made of a material selected from a metal, alloy, leather, stone, bone, wood, plastic, polymers, resins, organics and synthetic material.

81. An apparatus as claimed in claim 47 wherein said lock adaptor receiving means has a slot to accept the said locking tongue of said locking head, wherein said lock head includes a lock accessible from the outside of said lock head to rotate said locking tongue upon passing through said lock adaptor slot to be within said lock adaptor receiving means to engage against the interior of said lock adaptor to prevent withdrawal of said locking head from said lock adaptor.
